(19) United States
(12) Patent Application Publication
(10) Pub. No.: US 2023/0042906 A1
(43) Pub. Date: Feb. 9, 2023

(54) MOBILE SPRAY MANIFOLD ASSEMBLY

(71) Applicant: Amped Equipment, LLC, Philadelphia, PA (US)

(72) Inventors: Richard I. MOORE, Ambler, PA (US); Brent SMITH, Weston, MO (US)

(21) Appl. No.: 17/882,016

(22) Filed: Aug. 5, 2022

Related U.S. Application Data
(60) Provisional application No. 63/229,880, filed on Aug. 5, 2021.

(51) Int. Cl. B05B 13/02; B05B 13/00; E04D 15/07

(52) U.S. Cl. CPC B05B 13/0278; B05B 13/005; E04D 15/07; B05B 7/0093

(57) ABSTRACT

A mobile spray manifold assembly has a frame and at least one attachment arm secured to and extending from the frame and configured to removably mount to a vehicle for movement and maneuvering of the mobile spray assembly. A spray manifold is removably secured to, and supported by, the frame and has a plurality of spray nozzles mounted thereto and configured to spray a substance onto an underlying surface. A distribution manifold has an inlet and a plurality of outlets fluidly connected with the plurality of spray nozzles in parallel. A valve system is positioned upstream of the distribution manifold and fluidly connected with the inlet of the distribution manifold. The valve system includes a first flow control valve configured for fluid connection with a first substance containing container and a second flow control valve configured for fluid connection with a second substance containing container.

### CROSS-REFERENCE TO RELATED APPLICATIONS

This application claims priority from similarly-titled U.S. Provisional Patent Application No. 63/229,880, filed Aug. 5, 2021, the entire contents of which are incorporated by reference herein.

### BACKGROUND OF THE DISCLOSURE

The disclosure generally relates to a spray manifold assembly, and, more particularly, a spray manifold assembly for the roofing industry.

In the roofing industry, replacing an old roof, re-roofing or installing a new roof, requires a new roofing layer to be laid down. Multiple different materials are required to lay down a new roofing layer, such as, for example, roofing adhesive (e.g., a foam adhesive) and insulation (e.g., spray foam insulation).

It would, therefore, be advantageous to manufacture a mobile spray manifold assembly configured to spray a large area, such as a rooftop, in a more efficient manner.

### BRIEF SUMMARY OF THE DISCLOSURE

Briefly stated, one aspect of the present disclosure is directed to a mobile spray manifold assembly having a frame and at least one attachment arm secured to and extending from the frame and configured to removably mount to a vehicle for movement and maneuvering of the mobile spray assembly. A spray manifold is removably secured to, and supported by, the frame and has a plurality of spray nozzles mounted thereto and configured to spray a substance onto an underlying surface. A distribution manifold has an inlet and a plurality of outlets fluidly connected with the plurality of spray nozzles in parallel. A valve system is positioned upstream of the distribution manifold and fluidly connected with the inlet of the distribution manifold. The valve system includes a first flow control valve configured for fluid connection with a first substance containing container and a second flow control valve configured for fluid connection with a second substance containing container. The first flow control valve is selectively actuatable between an open position fluidly connecting the first container with the distribution manifold, and, in turn, with the spray nozzles, and a closed position, fluidly disconnecting the first container from the distribution manifold, and in turn, from the spray nozzles. The second flow control valve is independently selectively actuatable between an open position fluidly connecting the second container with the distribution manifold, and, in turn, with the spray nozzles, and a closed position, fluidly disconnecting the second container from the distribution manifold, and in turn, from the spray nozzles.

### BRIEF DESCRIPTION OF THE SEVERAL VIEWS OF THE DRAWINGS

The following description of the disclosure will be better understood when read in conjunction with the appended drawings. It should be understood, however, that the disclosure is not limited to the precise arrangements and instrumentalities shown. In the drawings:

FIG. 1 is a top, front and side perspective view of a spray manifold assembly in accordance with an embodiment of the present disclosure;

FIG. 2 is a top, front and side perspective view of a frame of the spray manifold assembly of FIG. 1;

FIG. 3 is a rear elevational view of a spray manifold of the spray manifold assembly of FIG. 1;

FIG. 4 is a front and top perspective view of the spray manifold assembly of FIG. 1 mounted upon a mobile cart and connected with first and second containers;

FIG. 5A is a top perspective view of a power box electrically connectable with the spray manifold assembly of FIG. 1;

FIG. 5B is a top plan view of the power box of FIG. 5A;

FIG. 6 is a top, front and side perspective view of an alternative configuration of the spray manifold assembly of FIG. 1, employing two spray manifolds;

FIG. 7 is a top and side perspective view of the spray manifold assembly of FIG. 1 mounted upon a mobile cart;

FIG. 8 is a top and side perspective view of the spray manifold assembly of FIG. 6 mounted upon the mobile cart; and

FIG. 9 is a schematic, view of an alternative configuration of a spray manifold of the spray manifold assembly of FIG. 1, having more than one distribution manifold.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the spray manifold assembly, and designated parts thereof, in accordance with the present disclosure. In describing the tray, the term proximal is used in relation to the upper end of the device and the term distal is used in relation to the bottom end of the device. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

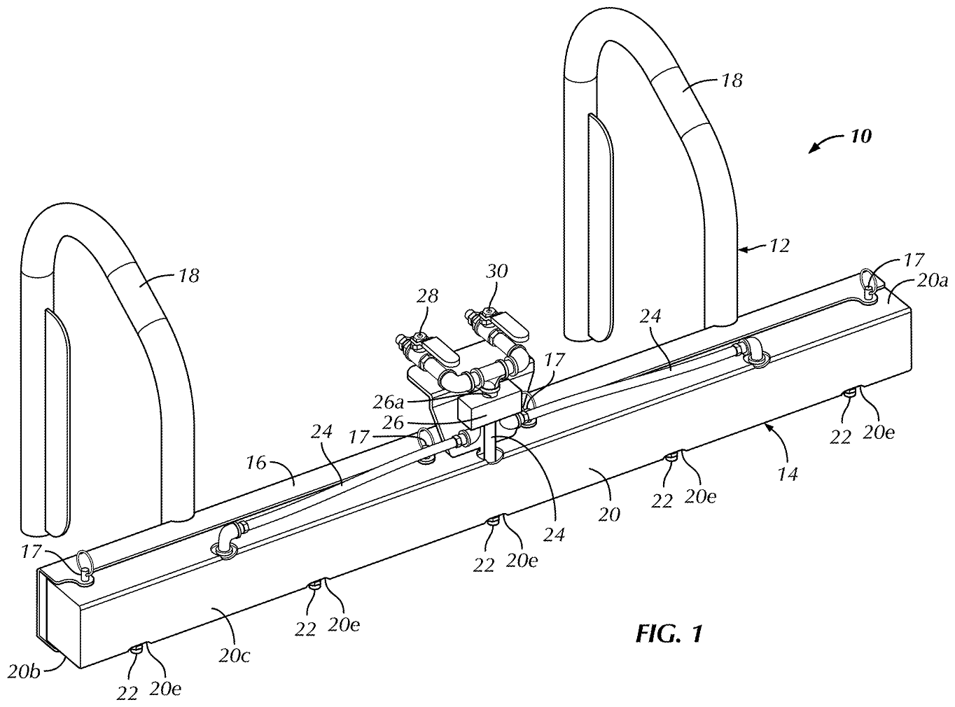

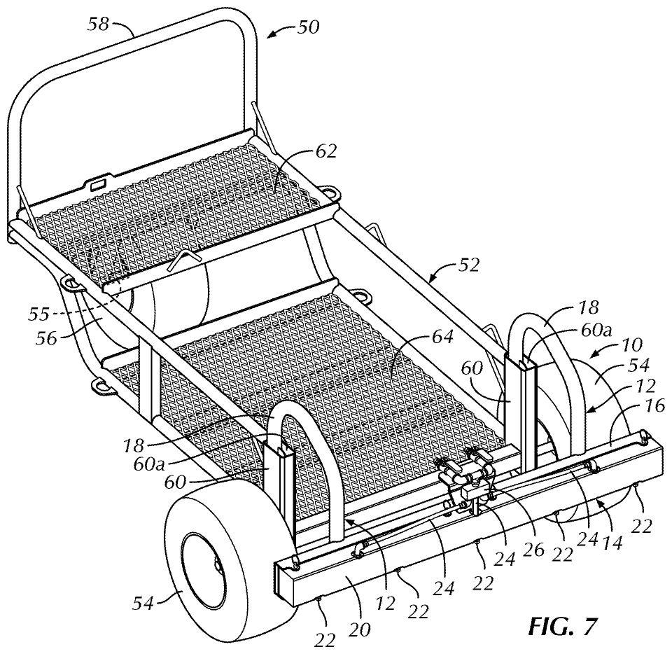

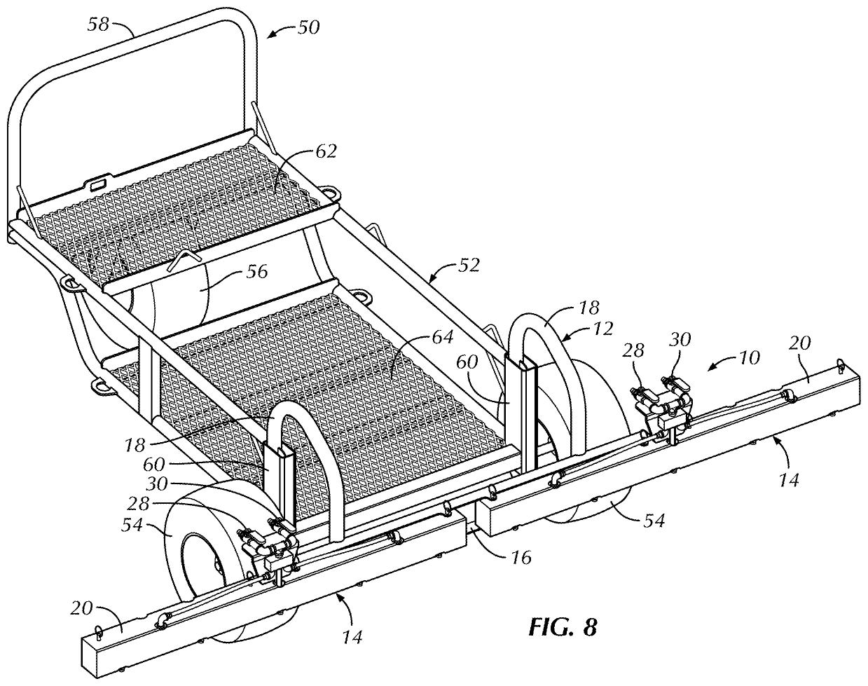

Referring to the drawings in detail, wherein like numerals indicate like elements throughout, there is shown in FIGS. 1-9 a mobile spray manifold assembly, generally designated 10, in accordance with an embodiment of the present disclosure. In one configuration, as shown in FIGS. 7 and 8, the spray manifold assembly 10 is configured for use with a mobile cart 50 (as will be described in further detail below).

As shown, the spray manifold assembly 10 includes a frame 12 upon which a spray manifold 14 is mounted. In one configuration, the frame 12 includes a main support bracket 16 and at least one attachment arm 18 extending therefrom. In the illustrated embodiment, the support bracket 16 is generally linear and horizontally oriented (in a ready to use orientation), but the disclosure is not so limited. In the illustrated embodiment, two spaced apart attachment arms 18 project generally transversely from the support bracket 16, but the disclosure is not so limited (as one or more than two attachment arms 18 or other attachment mechanisms may be employed). In one configuration, the attachment arm(s) 18 is fixedly attached to the support bracket 16, e.g., welded or otherwise integrated with the support bracket 16 or monolithically formed therewith. The attachment arm(s) 18 is formed to removably attach the spray manifold assembly 10 to a vehicle, e.g., such as the mobile cart 50, to assist with moving and maneuvering the assembly 10. Conversely, the attachment arm(s) 18 may operate as a handle for holding the assembly 10.

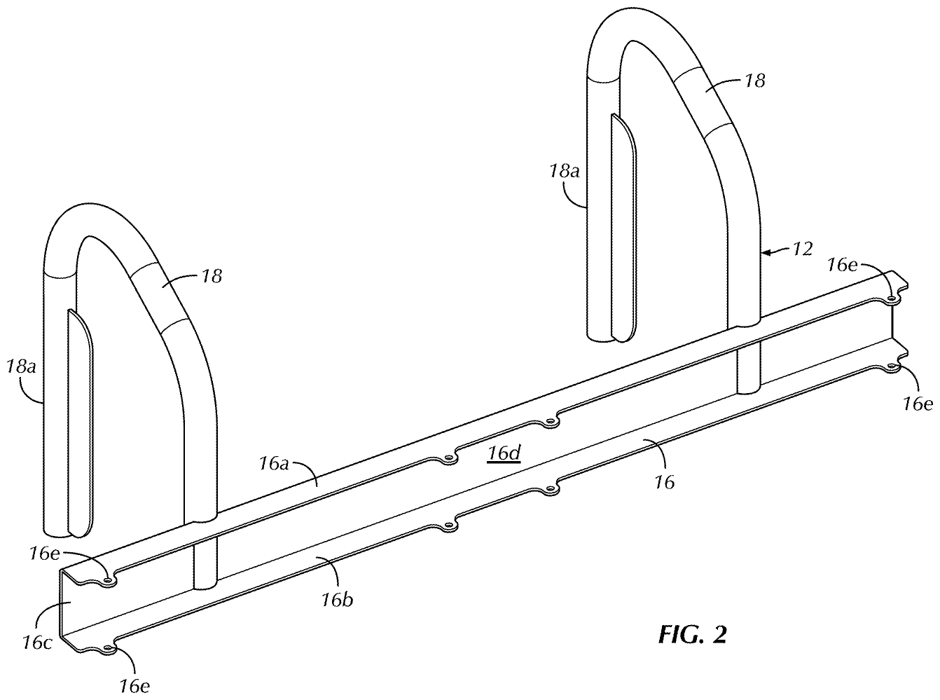

As shown best in FIG. 2, the support bracket 16 includes a top member 16a, a bottom member 16b and a side member 16c oriented perpendicularly therebetween, forming a channel 16d, e.g., generally U-shaped, for slidably and removably receiving the spray manifold 14. The top and bottom members 16a, 16b include a plurality of pairs of coaxial attachment apertures 16e, such that a pin 17, e.g., a detent or other spring actuated pin, a bolt or other fastener may extend through a respective pair of the coaxial apertures 16e to secure the spray manifold 14.

In the illustrated embodiment, and similar to the support bracket 16, the spray manifold 14 also includes a manifold bracket 20 having a top member 20a, a bottom member 20b and a side member 20c oriented perpendicularly therebetween, forming a generally U-shaped channel 20d. In one configuration, the manifold bracket 20 is approximately five feet in length, but the disclosure is not so limited. The spray manifold 14 is generally dimensioned for slidable engagement with the support bracket 16. The spray manifold 14 has plurality of pairs of coaxial attachment apertures 20f spaced apart to enable alignment with at least some of the plurality of pairs of coaxial attachment apertures 16e, for advancement of the respective pins 17 through a set of aligned apertures 16e and 20f and to secure the spray manifold 14 to the support bracket 16. As should be understood by those of ordinary skill in the art, however, the spray manifold 14 may be mountable upon, and securable to, the support bracket 16 via any of numerous mounting and fixation means currently known or that later become known.

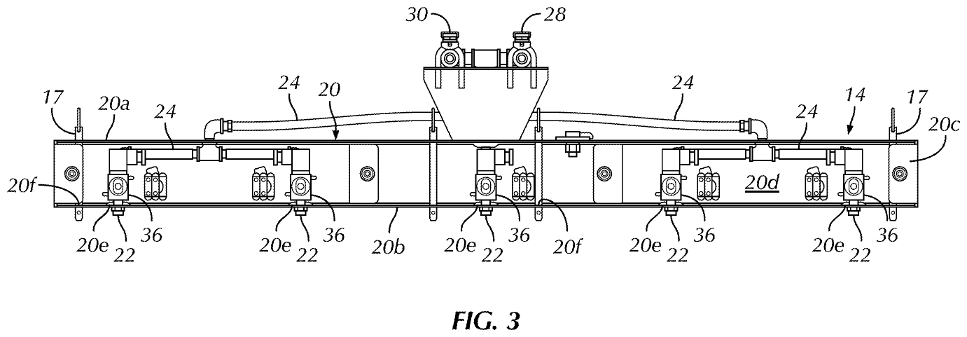

The spray manifold 14 further includes a plurality of spray nozzles/tips 22 mounted therein and projecting out of, or otherwise facing, corresponding openings 20e in the bottom member 20b of the manifold bracket 20. In one configuration, as shown in FIG. 1, the spray manifold 14 includes five spray nozzles 22, but the disclosure is not so limited. As should be understood, the spray manifold 14 may include less or more than five spray nozzles 22, according to different factors, such as, for example, but not limited to, the length of the manifold bracket 20, the desired spray pattern, the spacing between the spray nozzles 22 and the coverage area, i.e., spray angle, of each spray nozzle 22. In one configuration, at least some differing spray nozzles 22 may be employed or alternatively the same spray nozzles 22 may be employed in the spray manifold 14. As shown in FIGS. 1, 3, the spray nozzles 22 are all fluidly connected with a distribution manifold 26 upstream thereof. In the illustrated embodiment, the distribution manifold 26 is positioned externally to the manifold bracket 20, but the disclosure is not so limited. A network of conduits 24, e.g., pipes, flexible tubes, a combination thereof, or the like, extends from the spray nozzles 22 to the distribution manifold 26. In the illustrated embodiment, the distribution manifold 26 includes a single inlet 26a and multiple outlets fluidly connected to the conduits 24 in parallel, but the disclosure is not so limited. For example, the distribution manifold 26 may include more than one inlet 26a. In one configuration, the spray nozzles 22 are removably mounted within the manifold bracket 20 and disconnectable from the respective conduits 24, such that the spray nozzles 22 may be replaced, e.g., to replace damaged or poorly functioning nozzle 22 or two employ spray nozzle 22 with different spray patterns/spray angles.

As shown best in FIG. 1, the inlet 26a of the distribution manifold 26 is fluidly connected with an upstream valve system. In the illustrated embodiment, the valve system includes two valves 28, 30 positioned in parallel and each connected with the inlet 26a of the distribution manifold 26, but the disclosure is not limited to only two valves. In the illustrated embodiment, the valves 28, 30 take the form of ball valves, but the disclosure is not so limited. As should be understood by those of ordinary skill in the art, the valves 28, 30 may each take the form of any type of flow control valve capable of selectively fluidly connecting and selectively fluidly disconnecting the inlet and outlet ends thereof, currently known or that later becomes known.

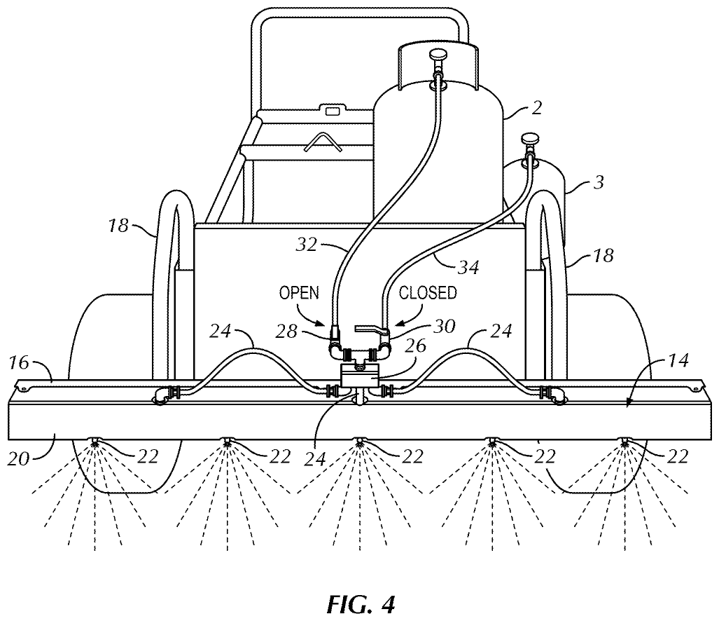

As shown best in FIG. 4, the first valve 28 is fluidly connected to a first container 2 containing a material via a conduit 32, e.g., a pipe, a flexible tube or the like, and the second valve 30 is fluidly connected to a second container 3 containing a material via a conduit 34. In the illustrated embodiment, the containers 2, 3 take the form of high-pressure tanks with a respective manually controlled valve at the top, but the disclosure is not so limited. For example, without limitation, one or both of the containers 2 may take the form of a drum. In one configuration, one or both of the containers 2, 3, may contain an adhesive, a spray foam insulation or the like. In one configuration, the adhesive may take the form of a single tank adhesive system substance (single component adhesive system), e.g., a methylene chloride-free based substance not requiring stirring. In one configuration one of the containers 2, 3 may contain an adhesive cleaner (known by those of ordinary skill in the art).

In one example of use, the first tank 2 may contain a single component adhesive and the second tank 3 may contain an adhesive cleaner. The tank valves are opened for each tank 2, 3 with the flow control valves 28, 30 oriented in the respective closed positions thereof. Thus, the tanks 2, 3 are in fluid communication with the inlets of the flow control valves 28, 30, respectively, via the conduits 32, 34, respectively. Thereafter, the first flow control valve 28 may be actuated to the open position thereof (in a manner well understood by those of ordinary skill in the art) to fluidly communicate the tank 2 with the spray nozzles 22, via the distribution manifold 26 and the conduits 24. Thus, as shown in FIG. 4, the spray nozzles 22 spray the pressurized single component adhesive onto the underlying surface, e.g., a rooftop surface or a ground surface. To cease spray, the first flow control valve 28 is actuated back to the closed position thereof. Thereafter, and/or beforehand if desired, the second flow-control valve 30 may be actuated to the open position thereof (in a manner well understood by those of ordinary skill in the art) to fluidly communicate the tank 3 with the spray nozzles 22, via the distribution manifold 26 and the conduits 24. Thus the adhesive cleaner may flow through, and clean/purge, the distribution manifold 26, the conduits 24 and the spray nozzles 22. After sufficient cleaning/purging, the second flow-control valve 30 may be actuated back to the closed position thereof. Advantageously, therefore, the spray manifold assembly 10 is self-cleaning to prevent clogging and sticking of the spray nozzles 22.

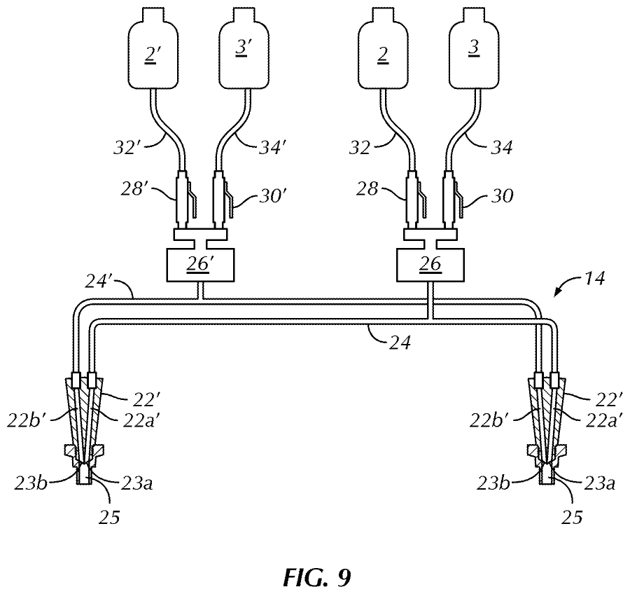

In another configuration, as shown in FIG. 9, the adhesive may take the form of a two-component adhesive, e.g., two-part epoxy-based or urethane-based component adhesive, wherein the first container 2 contains a first of the two components and a third container 2′ (e.g., also supported by the mobile cart 50) contains the second of the two components. For example, without limitation, one of the first and third containers 2, 2′ may contain a polymetric isocyanate substance and the other of the first and third containers 2, 2′ may contain a surfactant and catalysis containing substance. In such a configuration, the spray manifold 14 may include more than one distribution manifold, e.g., two distribution manifolds 26, 26′, and an associated upstream valve system for each distribution manifold 26, 26′, respectively. The first valve 28, connected with the first distribution manifold 26, for example, may be connected via conduit 32 with a tank/container 2 containing a first component of the two-component adhesive. The first valve 28′, connected with a second distribution manifold 26′, may be connected via conduit 32′ with a tank/container 2′ containing a second component of the two-component adhesive. Each distribution manifold 26, 26′ may include a respective network of conduits 24, 24′ extending therefrom to the respective nozzles 22′.

Each nozzle 22′ may include separate internal first and second passages 22a′ and 22b′. The first passage 22a′ is fluidly connected at an inlet thereof with the conduit 24 and the second passage 22b′ is fluidly connected at an inlet thereof with the conduit 24′, such that each passage 22a′, 22b′ receives a respective one of the components of the two-component adhesive. The outlets 23a, 23b of the first and second passages 22a′ and 22b′, respectively, are oriented such that the first and second components of the adhesive mix together downstream thereof. Optionally a disposable mixing tip 25 may be removably attached to the outlet side of the nozzle 22′ wherein the first and second components of the adhesive combined and are mixed within the tip 25 and then sprayed therefrom.

The second container 3 may remain containing an adhesive cleaner. Alternatively, the second container 3 may take the form of a pressurized air source such as an air compressor. A fourth container 3′ (e.g., also supported by the mobile cart 50) may also be provided, and may also contain an adhesive cleaner or take the form of a pressurized air source. The second valve 30, connected with the first distribution manifold 26 may be connected with the third tank/container 3. The second flow control valve 30′ connected with the second distribution manifold 26′, may be connected with a fourth container 3′ via conduit 34′. The second flow control valve 30 is connected between the second container 3 (via conduit 34) and distribution manifold 26 as previously described.

In one example of use, the tank valves are opened for each tank 2, 2′ with the first flow control valves 28, 28′ oriented in the respective closed positions thereof. Thus, the tanks 2, 2′ are in fluid communication with the inlets of the first flow control valves 28, 28′, respectively, via the conduits 32, 32′, respectively. Thereafter, the first flow control valves 28, 28′ may be actuated to the open position thereof (in a manner well understood by those of ordinary skill in the art) to fluidly communicate the tanks 2, 2′ with the respective spray nozzles 22′, via the respective distribution manifolds 26, 26′ and the conduits 24, 24′. The spray nozzles 22′ deliver the two components to the respectively attached mixing tips 25, wherein the two components are mixed to form the two-part adhesive and subsequently sprayed onto the underlying surface, e.g., in a bead pattern. To cease spray, the first flow control valves 28, 28′ are actuated back to the closed position thereof. As should be understood, this configuration may still be used with a single part adhesive, wherein one of this distribution manifolds 26, 26′ is not used, i.e., the flow control valves associated therewith remain closed.

Optionally, at least one of the second and fourth containers 3, 3′ may be employed in the form of a source of pressurized air or an air compressor. Accordingly, at least one of the second flow control valves 30, 30′ may be actuated to the open position along with the first flow control valves 28, 28′ to also deliver pressurized air to the respective nozzles 22′ and the associated, respective mixing tips 25. Alternatively, a separate conduit (not shown) may extend from the source of pressurized air or an air compressor 3, 3′ directly to the mixing tip 25, and the first component, the second component and the air may mix in the mixing tip 25. Thus, the two-part adhesive in combination with the pressurized air may be sprayed onto the underlying surface in a splatter pattern.

Thereafter, and/or beforehand if desired, the second flow-control valves 30, 30′ may be connected to adhesive cleaner containing tanks and actuated to the open position thereof to fluidly communicate the adhesive cleaner containing tanks with the spray nozzles 22′ (as previously described) for the adhesive cleaner to flow through, and clean/purge, the distribution manifolds 26, 26′, the conduits 24, 24′ and the spray nozzles 22′. The mixing tips 25 may also be cleaned/purged, or replaced.

In one configuration, as shown best in FIG. 3, the spray tips 22 may be controlled via respective solenoid valves 36. That is, a solenoid valve 36 is employed in line proximate, or upstream of, the inlet of each spray nozzle 22. Thus, each respective conduit 24 is fluidly communicated with the corresponding spray nozzle 22 when the solenoid valve 36 is electrically actuated from the closed position thereof to the open position thereof. As should be understood, solenoid valves 36 may be employed in like manner in configurations employing spray nozzles 22′, wherein more than one distribution manifold 26, 26′ and associated conduits 24, 24′ are also employed. For the sake of brevity, however, the following disclosure refers to the configuration employing the spray nozzles 22 but equally applies to the configuration employing the spray nozzles 22′.

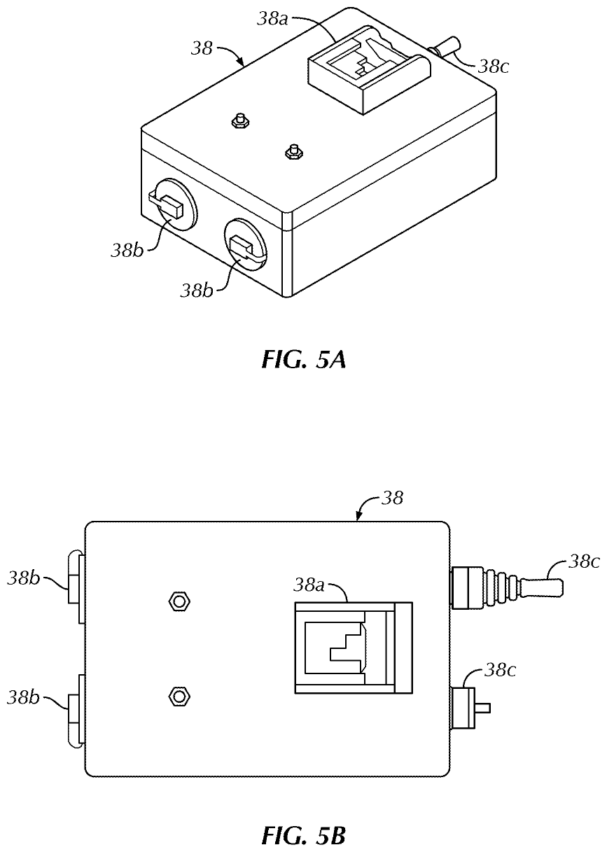

In configurations employing solenoid valves 36, a power supply box 38 (see FIGS. 5A, 5B) may be electrically connected with each of the solenoid valves 36 in a manner well understood by those of ordinary skill in the art, e.g., via wiring. As shown, the power supply box 38 includes a battery cradle 38a for receiving a battery (not shown), e.g., a 12V or 24V battery, to power the solenoid valves 36. Advantageously, therefore, a common, standard power supply may power the spray manifold assembly 10. The power supply box 38 includes at least one power outlet 38b configured to receive an electrical plug (not shown) connected with the solenoid valves 36. The power box 38 also includes at least one power switch 38c configured to selectively connect (“on”) or disconnect (“off”) a circuit (not shown—inside the power box 38) between the battery cradle 38a and the power outlet(s) 38b. Thus, in a configuration employing the solenoid valves 36, the solenoid valves 36 are electrically connected with the power outlet(s) 38b and a battery is inserted into the battery cradle 38a to power the valves 36.

A user may operate the spray manifold assembly 10 as previously described. Additionally, the user actuates the switch 38c to the “on” position to electrically connect and open the solenoid valves 36, and, in turn, fluidly connect the conduits 24 (and the upstream system previously described) with the respective spray nozzles 22. A user may also selectively actuate the switch 38c to the “off” position, and, in turn, close the solenoid valves 36, thereby turning the spray nozzles 22 off. Such steps may be performed before or after closing a respective valve 28, 30 to provide the user with additional, more ergonomic control over the system. In one configuration, each solenoid valve 36 may additionally employ a respective electric switch (not shown) connected between the associated valve 36 and the power supply box 38. Accordingly, a user may also selectively activate/deactivate individual spray nozzles 22 rather than activating or deactivating all of the spray nozzles 22 together.

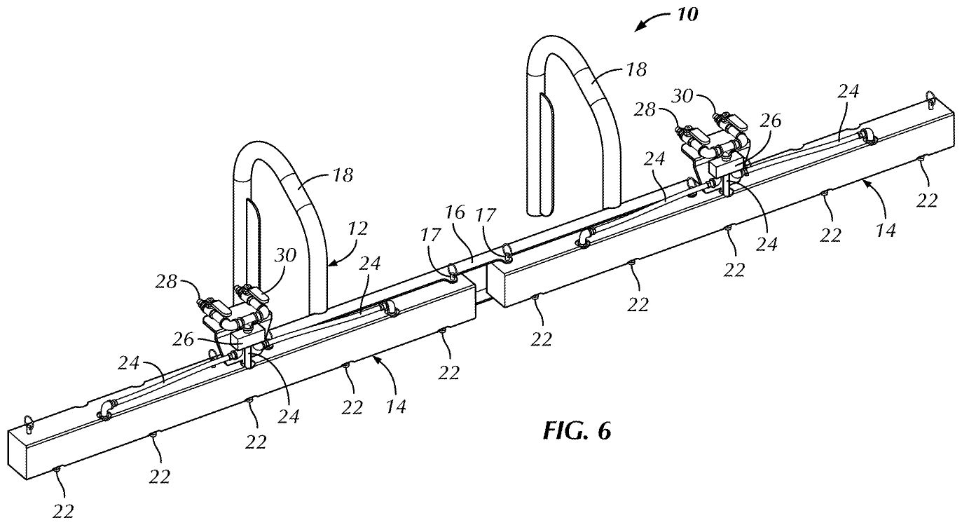

Advantageously, more than one spray manifold 14 may be mounted upon the support bracket 16 to increase the overall spray coverage of the spray manifold assembly 10. For example, without limitation, two five-foot-long spray manifolds 14 may be mounted to the support bracket 16 to form a ten-foot-long total spray coverage area. In the illustrated embodiment of FIG. 6, two spray manifolds 14 are mounted upon the support bracket 16, generally as previously described. However, each of the two spray manifolds 14 is laterally offset to one side of the support bracket 16, whereby at least one of the of pairs of coaxial attachment apertures 20f of each spray manifold 14 overlaps with a corresponding at least one of the of pairs of coaxial attachment apertures 16e of the support bracket. As should be understood by those of ordinary skill in the art, however, the spray manifolds 14 may be mountable upon, and securable to, the support bracket 16 via any of numerous mounting and fixation means currently known or that later become known. As should be understood, the multiple spray manifold 14 configuration may be employed in like manner in configurations employing more than one distribution manifold 26, 26′ per spray manifold 14. For the sake of brevity, however, the following disclosure refers to the configuration wherein each spray manifold 14 includes a single respective distribution manifold 26.

In a multiple spray manifold 14 configuration, such as shown in FIG. 6, each of the conduits 32 of each spray manifold 14 is fluidly connected with the first container 2 and each of the conduits 34 of each spray manifold 14 is connected to the second container 3. For example, without limitation, the conduits 32 may be fluidly connected to the first container 2 via a distribution manifold (not shown) and the conduits 34 may be fluidly connected to the second container 3 via another distribution manifold (not shown), but the disclosure is not so limited. For example, without limitation, each spray manifold 14 may be alternatively connected to a separate, corresponding first and second containers 2, 3. In a configuration where electric solenoid valves 36 are employed, the solenoid valves 36 of each spray manifold 14 are electrically connected with the power box 38 via a respective power outlet 38b thereof. Alternatively, a separate power box 38 may be provided for each spray manifold 10.

In one configuration, the spray manifold assembly 10 may further include a wind skirt (not shown) configured to protect the spray nozzles 22 from the elements. The wind skirt may be removably attached to the support bracket 16 and/or the spray manifold 14, via any of numerous fastening means well understood by those of ordinary skill in the art, and extend downwardly toward the underlying surface. The wind skirt may be configured to extend from the front side of the spray manifold assembly 10 (i.e., the side facing away from a cart 50 as explained below). Additionally, the wind skirt may wrap around the left, front and right sides of the support bracket 16 and spray manifold 14. In one configuration, the wind skirt may be transparent to enable visualization of the sprayed material during spraying. Advantageously, the wind skirt may assist in reducing the effect of wind, e.g., on a rooftop, on the spray pattern of the spray nozzles 22.

In one configuration, as shown in FIGS. 7 and 8, the spray manifold assembly 10 may be mounted upon a mobile cart 50. The mobile cart 50 may take any of multiple different configurations. Generally, the cart 50 includes a frame, i.e., chassis, 52, having a pair of wheels 54 proximate one end of the frame 52 and a wheel 56 (spaced axially from the wheels 54) proximate an opposing end of the frame 52. The wheels 54, 56 extend downwardly from the frame 52 and support the frame 52 atop an underlying surface, e.g., a ground surface or a rooftop surface.

The wheels 54 are connected to the frame 52 in a manner well understood by those of ordinary skill in the art, such that the wheels 54 solely and freely rotate in both directions about a common central axis extending therebetween. The wheel 56 is also connected to the frame 52 in a manner well understood by those of ordinary skill in the art, such that the wheel 56 can both rotate in both directions about a central axis thereof extending in a direction parallel to the underlying surface, and also may swivel about a central axis thereof extending in a direction perpendicular to the underlying surface via a standard yoke mounting arrangement 55. Accordingly, the wheel 56 is the steering wheel of the cart 50. As should be understood, the wheel 56 may be substantially aligned with a midway point of the wheelbase/track between the wheels 54 to stabilize the frame 52 atop the wheels. As also should be understood, the cart 50 may alternatively include a pair of wheels 56. Above the wheel 56, a cart handle 58 extends substantially vertically upwardly from the frame 52 for grasping by a user to move, e.g., pull, and maneuver the cart 50 and the contents thereon and/or attached thereto.

In the exemplary illustrated embodiment of the cart 50, the frame 52 includes a pair of substantially vertical frame posts 60 at an end of the frame 52 opposite the handle 58. In the illustrated embodiment of the cart 50, the frame posts 60 each define a respective corner of the frame 52, one post 60 being positioned proximate each of the wheels 54. The frame posts 60 each define an open-topped internal channel 60a. The frame 52 further includes an upper platform 62 proximate the cart handle 58, and an elevationally lower platform 64 (closer to the support surface underlying the cart 50) extending to the posts 60.

As shown in FIGS. 4, 7 and 8, the attachment arms 18 of the spray manifold assembly 10 may be spaced apart to align with the posts 60. The attachment arms may be generally U-shaped, whereby a rear, terminal vertical section 18a of each attachment arm 18 is slidably insertable into a corresponding channel 60a of the posts 60. Accordingly, the spray manifold assembly 10 is removably mountable upon the cart 50. As shown in FIG. 4, the containers 2 and 3 may also be supported by the cart 50. Therefore, the cart 50 may be moved, e.g., pushed or pulled by the cart handle 58, while operating the spray manifold assembly 10 as previously described, to spray a large area more efficiently, such as a rooftop.

In one configuration, the first and/or second containers 2, 3 may additionally or alternatively be fluidly connected to spray wands (not shown) to assist with adhesive spraying of a desired area. The spray manifold assembly 10 and the spray wand(s) may both be fluidly connected with one or both of the first and second containers 2, 3, via a distribution manifold (not shown) or a conventional three-way valve (not shown) attached to the outlet valve of each of the containers 2, 3. Each three-way valve may be actuated between three positions: fluidly disconnected, fluidly connected to the spray manifold assembly 10, and fluidly connected to the spray wand, in a manner well understood by those of ordinary skill in the art. The spray wand(s) may also be supported upon the cart 50.

It will be appreciated by those skilled in the art that various modifications and alterations could be made to disclosure above without departing from the broad inventive concepts thereof. Some of these have been discussed above and others will be apparent to those skilled in the art. It is understood, therefore, that this disclosure is not limited to the particular embodiments disclosed, but it is intended to cover modifications within the spirit and scope of the present disclosure, as set forth in the appended claims.

We claim:

1. A mobile spray manifold assembly comprising:
a frame;
at least one attachment arm secured to and extending from the frame and configured to removably mount to a vehicle for movement and maneuvering of the mobile spray assembly;
a spray manifold removably secured to, and supported by, the frame, the spray manifold having a plurality of spray nozzles mounted thereto and configured to spray a substance onto an underlying surface;
a distribution manifold having an inlet and a plurality of outlets fluidly connected with the plurality of spray nozzles in parallel; and
a valve system positioned upstream of the distribution manifold and fluidly connected with the inlet of the distribution manifold, the valve system comprising a first flow control valve configured for fluid connection with a first substance containing container and a second flow control valve configured for fluid connection with a second substance containing container, wherein the first flow control valve is selectively actuatable between an open position fluidly connecting the first container with the distribution manifold, and, in turn, with the spray nozzles, and a closed position, fluidly disconnecting the first container from the distribution manifold, and in turn, from the spray nozzles, and the second flow control valve is independently selectively actuatable between an open position fluidly connecting the second container with the distribution manifold, and, in turn, with the spray nozzles, and a closed position, fluidly disconnecting the second container from the distribution manifold, and in turn, from the spray nozzles.

2. The mobile spray manifold assembly of claim 1, wherein the spray manifold is slidably engageable with the frame, the frame having a plurality of apertures and the spray manifold having corresponding apertures, and further comprising a plurality of pins, each configured to extend through a coaxially aligned pair of the apertures of the frame and the spray manifold, respectively.

3. The mobile spray manifold assembly of claim 1, further comprising a plurality of solenoid valves corresponding to the plurality of spray nozzles, the solenoid valves being positioned proximate respective inlets of the spray nozzles and being electrically actuatable between an open position, fluidly connecting the distribution manifold with the spray nozzles, and a closed position, fluidly disconnecting the distribution manifold from the spray nozzles.

4. The mobile spray manifold assembly of claim 3, further comprising a power supply connected with the solenoid valves and a power switch configured to selectively actuate the solenoid valves between the open and closed positions thereof.

5. The mobile spray manifold assembly of claim 4, wherein the power supply comprises a 12V or a 24V battery.

6. The mobile spray manifold assembly of claim 1, wherein the spray manifold is a first spray manifold, the distribution manifold is a first distribution manifold, and the valve system is a first valve system, and further comprising a second spray manifold, a second distribution system and a second valve system, wherein the first and second spray manifolds are both removably secured to, and supported by, the frame.

7. The mobile spray manifold assembly of claim 6, wherein the first flow control valve of the first valve system is configured for fluid connection with the first substance containing container, the first flow control valve of the second valve system is configured for fluid connection with the first substance containing container, the second flow control valve of the first valve system is configured for fluid connection with the second substance containing container, and the second flow control valve of the second valve system is configured for fluid connection with the second substance containing container

8. The mobile spray manifold assembly of claim 1, further comprising a wind skirt extending downwardly from the spray manifold toward the underlying surface and configured to protect the spray nozzles.

9. The mobile spray manifold assembly of claim 1, wherein the wind skirt is transparent.

10. The mobile spray manifold assembly of claim 1 in combination with a mobile cart, the mobile cart comprising a chassis having a plurality of wheels extending downwardly therefrom to support the frame atop the underlying surface, wherein the frame includes at least one substantially vertical post proximate an end of the chassis and defining an open-topped internal channel, wherein the at least one attachment arm is slidably removably, slidably received within the open-topped internal channel.

11. The combination mobile spray manifold and mobile cart of claim 10, wherein the at least one attachment arm is generally U-shaped, wherein a terminal, generally vertical section of the at least one generally U-shaped attachment arm is slidably removably, slidably received within the open-topped internal channel.

12. The combination mobile spray manifold and mobile cart of claim 10, wherein the plurality of wheels comprises a pair of wheels proximate one end of the chassis and a single wheel proximate an opposing end of the chassis, the pair of wheels being rotatable about a common central axis extending therebetween and the single wheel being rotatable about a central axis parallel to the common central axis and also being swivelable about an axis perpendicular to the underlying surface.

13. The combination mobile spray manifold and mobile cart of claim 10, further comprising the first container and the second container supported by the mobile cart.
